(19) United States
(12) Patent Application Publication
(10) Pub. No.: US 2026/0361467 A1
(43) Pub. Date: Nov. 12, 2026

(54) TRANSPORT BLOCK REPETITIONS FOR PHYSICAL UPLINK SHARED CHANNEL WITH ORTHOGONAL COVER CODES

(71) Applicant: QUALCOMM Incorporated, San Diego, CA (US)

(72) Inventors: Syed Hashim Ali SHAH, Littleton, MA (US); Alberto RICO ALVARINO, San Diego, CA (US)

(21) Appl. No.: 19/644,906

(22) Filed: Apr. 10, 2026

Related U.S. Application Data
(60) Provisional application No. 63/801,691, filed on May 7, 2025.

(51) Int. Cl. H04L 1/1867; H04L 5/00

(52) U.S. Cl. CPC H04L 1/1893; H04L 5/0016

(57) ABSTRACT

This disclosure provides methods, components, devices and systems for transport block repetitions for physical uplink shared channel with orthogonal cover codes. This disclosure provides methods, components, devices and systems for repetitions of transport blocks with orthogonal cover codes for physical uplink shared channel transmissions. For example, a user equipment (UE) may determine that the UE has data to transmit across a quantity of repetitions. The UE may determine a set of transmission occasions to which the UE may apply a redundancy version sequence associated with the quantity of repetitions. The UE may transmit the quantity of repetitions starting on an initial transmission occasion of the set of transmission occasions that is available for the UE to start transmission based on the redundancy version sequence and in accordance with an OCC factor.

### CROSS REFERENCE

This Patent application claims the benefit of U.S. Provisional Patent Application No. 63/801,691 by SHAH et al., entitled “TRANSPORT BLOCK REPETITIONS FOR PHYSICAL UPLINK SHARED CHANNEL WITH ORTHOGONAL COVER CODES,” filed May 7, 2025, assigned to the assignee hereof, and expressly incorporated herein.

### TECHNICAL FIELD

This disclosure relates generally to wireless communication, and more specifically to systems, devices, methods, and techniques associated with transport block repetitions for physical uplink shared channel with orthogonal cover codes.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a user equipment (UE) is described. The method may include determining that the UE has data to transmit across a quantity of repetitions using orthogonal cover codes (OCCs), determining a set of transmission occasions to which the UE applies a redundancy version (RV) sequence associated with the quantity of repetitions, and transmitting the quantity of repetitions starting on an initial transmission occasion of the set of transmission occasions, where the initial transmission occasion is available for the UE to start transmitting the quantity of repetitions based on the RV sequence and in accordance with an OCC factor.

A UE for wireless communication is described. The UE may include a processing system that includes processor circuitry and memory circuitry that stores code. The processing system may be configured to cause the UE to determine that the UE has data to transmit across a quantity of repetitions using OCCs, determine a set of transmission occasions to which the UE applies an RV sequence associated with the quantity of repetitions, and transmit the quantity of repetitions starting on an initial transmission occasion of the set of transmission occasions, where the initial transmission occasion is available for the UE to start transmitting the quantity of repetitions based on the RV sequence and in accordance with an OCC factor.

Another UE for wireless communication is described. The UE may include means for determining that the UE has data to transmit across a quantity of repetitions using OCCs, means for determining a set of transmission occasions to which the UE applies an RV sequence associated with the quantity of repetitions, and means for transmitting the quantity of repetitions starting on an initial transmission occasion of the set of transmission occasions, where the initial transmission occasion is available for the UE to start transmitting the quantity of repetitions based on the RV sequence and in accordance with an OCC factor.

A non-transitory computer-readable medium storing code for wireless communication is described. The code may include instructions executable by one or more processors to determine that the UE has data to transmit across a quantity of repetitions using OCCs, determine a set of transmission occasions to which the UE applies an RV sequence associated with the quantity of repetitions, and transmit the quantity of repetitions starting on an initial transmission occasion of the set of transmission occasions, where the initial transmission occasion is available for the UE to start transmitting the quantity of repetitions based on the RV sequence and in accordance with an OCC factor.

Some examples of the method, UEs, and non-transitory computer-readable medium described herein may further include operations, features, means, or instructions for transmitting capability signaling indicating that the UE supports transmissions with OCCs, where transmitting the quantity of repetitions may be in accordance with the UE supporting the transmissions with OCCs.

Some examples of the method, UEs, and non-transitory computer-readable medium described herein may further include operations, features, means, or instructions for receiving control signaling indicating an OCC configuration, where the OCC configuration includes the OCC factor and an OCC codeword, and where transmitting the quantity of repetitions may be based on applying the OCC codeword to the data.

In some examples of the method, UEs, and non-transitory computer-readable medium described herein, transmitting the quantity of repetitions may include operations, features, means, or instructions for transmitting, for each repetition of the quantity of repetitions, a second quantity of messages corresponding to the OCC factor, where each message of the second quantity of messages may be transmitted on a single transmission occasion of the set of transmission occasions.

In some examples of the method, UEs, and non-transitory computer-readable medium described herein, the initial transmission occasion may be available based on an expected RV corresponding to the initial transmission occasion being RV zero in accordance with the redundancy version sequence and the initial transmission occasion corresponding to a beginning of an OCC group in accordance with the OCC factor.

In some examples of the method, UEs, and non-transitory computer-readable medium described herein, transmitting the quantity of repetitions may include operations, features, means, or instructions for transmitting each repetition of the quantity of repetitions over a second quantity of transmission occasions, where the second quantity of transmission occasions may be a product of the OCC factor and a factor indicating a third quantity of transmission occasions over which to perform rate matching for respective RVs corresponding to the each repetition.

In some examples of the method, UEs, and non-transitory computer-readable medium described herein, an expected RV corresponding to the initial transmission occasion may be calculated based on a first index value corresponding to the transmission occasion, the OCC factor, and the factor indicating the third quantity of transmission occasions.

### BRIEF DESCRIPTION OF THE DRAWINGS

FIG. 1 shows an example of a wireless communication system.

FIG. 2 shows an example of a signaling configuration that supports transport block repetitions for physical uplink shared channel with orthogonal cover codes.

FIG. 3 shows an example of a table that supports transport block repetitions for physical uplink shared channel with orthogonal cover codes.

FIG. 4 shows an example of a table that supports transport block repetitions for physical uplink shared channel with orthogonal cover codes.

FIG. 5 shows an example of a process flow that supports transport block repetitions for physical uplink shared channel with orthogonal cover codes.

FIG. 6 shows a block diagram of a processing system that supports transport block repetitions for physical uplink shared channel with orthogonal cover codes.

FIG. 7 shows a diagram of a system including a device that supports transport block repetitions for physical uplink shared channel with orthogonal cover codes.

FIGS. 8 through 10 show flowcharts illustrating methods that support transport block repetitions for physical uplink shared channel with orthogonal cover codes.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may support multiplexing multiple user equipments (UEs) to increase capacity of the wireless communications systems. In some examples, multiplexed UEs may use orthogonal cover codes (OCCs) to mitigate interference at a network entity between transmissions by the multiplexed UEs. For instance, a one slot transmission by a UE may be spread into a first quantity of slots after applying an OCC, where the first quantity corresponds to the OCC factor. In some cases, a UE may transmit multiple repetitions of a physical uplink shared channel (PUSCH) transmission, and the UE may be configured with a set of rules for determining transmission occasions on which the UE may begin transmitting the PUSCH transmission based on a redundancy version (RV) sequence. However, merely adjusting expected RVs of transmission occasions to account for an OCC factor and maintaining the set of rules may be insufficient for transmissions with OCCs. For example, a UE may transmit an OCC group spanning a quantity of transmission occasions that corresponds to an OCC factor for each repetition of a PUSCH transmission. The UE may begin transmitting repetitions of the PUSCH transmission on a first transmission occasion in accordance with the set of rules, but this first transmission occasion may be incompatible with the OCC factor, resulting in partial transmission of an OCC group. Partial transmission of the OCC group may result in loss of orthogonality between a transmission (e.g., a repetition) by the UE and one or more transmissions by one or more other UEs, preventing a network entity from successfully decoding the transmissions.

Aspects of the subject matter described in this disclosure relate to transport block (TB) repetitions for PUSCH with OCCs. For example, A UE may determine that the UE has data (e.g., PUSCH data) to transmit across a quantity of repetitions. The UE may apply an OCC codeword to the quantity of repetitions in accordance with an OCC configuration. The UE may determine a set of transmission occasions that the UE may use for transmitting the quantity of repetitions, and the UE may apply an RV sequence associated with the quantity of repetitions to the set of transmission occasions. For example, the UE may associate each transmission occasion of the set of transmission occasions with an expected RV based on the RV sequence and an OCC factor associated with the OCC configuration. The UE may determine which transmission occasions of the set of transmission occasions are available for the UE to start transmitting the quantity of repetitions based on the expected RVs and the OCC factor. The UE may accordingly start transmitting the quantity of repetitions on an available transmission occasion of the set of transmission occasions, and transmit the quantity of repetitions according to the determined RVs, applying the OCC codeword.

Particular aspects of the subject matter described in this disclosure can be implemented to realize one or more of the following potential advantages. In some examples, by supporting TB repetitions for PUSCH with OCCs, the described techniques can be used to simultaneously realize advantages of OCCs and PUSCH with repetition. For instance, TB repetitions for PUSCH may provide coverage enhancement for UEs and improve signal quality (e.g., signal-to-noise (SNR) ratio) of TB transmissions. Integrating the TB repetitions for PUSCH with OCCs may further allow a wireless communication system to increase a system capacity and support a greater quantity of UEs on a same set of time-frequency resources relative to wireless communication systems that do not support OCCs.

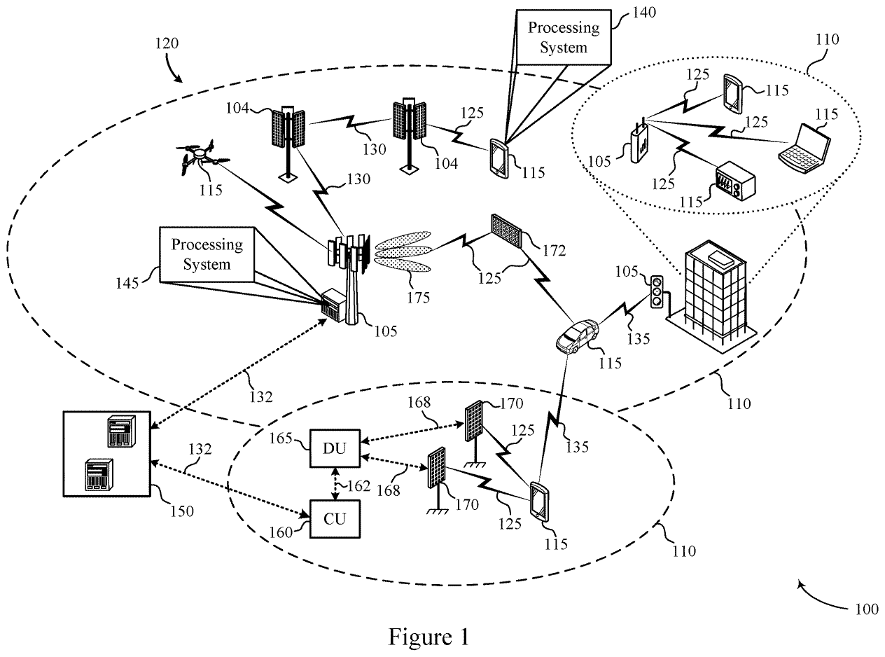

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface).

In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for TB repetitions for PUSCH with OCCs. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support TB repetitions for PUSCH with OCCs. For example, a UE 115 may determine that the UE 115 has data (e.g., PUSCH data) to transmit across a quantity of repetitions. The UE 115 may apply an OCC codeword to the quantity of repetitions in accordance with an OCC configuration. The UE 115 may determine a set of transmission occasions that the UE 115 may use for transmitting the quantity of repetitions, and the UE 115 may apply an RV sequence associated with the quantity of repetitions to the set of transmission occasions. For example, the UE 115 may associate each transmission occasion of the set of transmission occasions with an expected RV based on the RV sequence and an OCC factor associated with the OCC configuration. The UE 115 may determine which transmission occasions of the set of transmission occasions are available for the UE 115 to start transmitting the quantity of repetitions based on the expected RVs and the OCC factor. The UE 115 may accordingly start transmitting the quantity of repetitions on an available transmission occasion of the set of transmission occasions. The UE 115 transmitting repetitions of a TB to which an OCC is applied in accordance with the techniques described herein may allow a wireless communication system to increase capacity by multiplexing UEs 115 and mitigating interference with OCC while also improving reliability and signal quality of PUSCH transmissions through repetition.

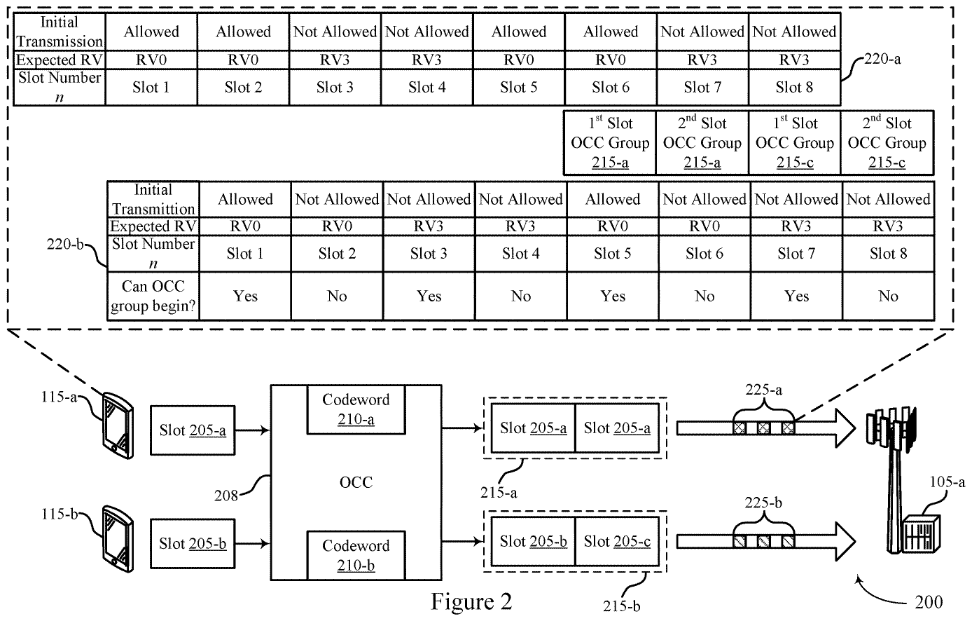

FIG. 2 shows an example of a signaling configuration 200 that supports TB repetitions for PUSCH with OCCs. In some examples, the signaling configuration 200 may implement, or be implemented by, aspects of the wireless communication system 100. For example, the signaling configuration 200 may include a UE 115-a, a UE 115-b, and a network entity 105-a, which may be examples of corresponding devices as described with reference to FIG. 1. In some cases, the network entity 105-a may be a component of a non-terrestrial network (NTN) such as aspects of a network entity implemented in a satellite or satellite gateway in communication with one or more satellites of an NTN.

In some examples, the signaling configuration 200 may implement one or more multiple access schemes, which may support multiplexing of multiple UEs 115 to increase a capacity of a wireless communication system. By multiplexing the multiple UEs 115, the one or more multiple access schemes may allow the wireless communication system to support a greater quantity of UEs 115 on a same quantity of time-frequency resources compared to communications without multiplexing. In some cases, multiplexing multiple UEs 115 may create interference at the network entity 105-a, which may be mitigated by implementing OCCs 208. Implementation of OCCs 208 may allow multiple UEs 115 to transmit PUSCH transmissions on a same time-frequency resource with minimal performance degradation. For instance, a one slot uplink transmission may be spread into a quantity of slots corresponding to an OCC factor in accordance with an OCC configuration, where the quantity of slots may be considered an OCC group. An OCC codeword may be applied across the OCC group, where the data transmitted in each slot of the quantity of slots is multiplied by a scalar value in accordance with the OCC codeword.

To illustrate, the UE 115-a may have data for transmission that corresponds to a slot 205-a, and the UE 115-b may likewise have data for transmission that corresponds to a slot 205-b. For an OCC configuration with an OCC factor of two, the UE 115-a may spread the slot 205-a across two slots and apply a codeword 210-a to the data. For instance, the codeword 210-a may be [1, 1], and the UE 115-a may transmit an OCC group 215-a including two instances of the slot 205-a. Likewise, the UE 115-b may spread the slot 205-b across two slots and apply a codeword 210-b to the data. The codeword 210-b may be [1, −1], and the UE 115-b may transmit an OCC group 215-b including a first slot that corresponds to the slot 205-b and a second slot 205-c that includes an inverse of the data corresponding to the slot 205-b (e.g., each symbol transmitted in the second slot 205-c being multiplied by the scalar −1). The OCC group 215-a and the OCC group 215-b may be orthogonal based on the codeword 210-a and the codeword 210-b, and the network entity 105-a may decode the OCC groups 215 and associate the OCC groups 215 with corresponding UEs 115 based on the orthogonality.

In some examples, the UE 115-a and the UE 115-b may transmit multiple repetitions of a PUSCH transmission to achieve coverage enhancement. In some cases, the signaling configuration 200 may support cover-coding data across the multiple repetitions (e.g., including in cases of TB over multiple slots (TBoMS), in which a UE 115 rate matches portions of a TB across multiple slots) in an orthogonal manner using OCC. For instance, the UE 115-a may transmit a quantity of repetitions 225-a and the UE 115-b may transmit a quantity of repetitions 225-b, which may be repetitions of the OCC group 215-a and the OCC group 215-b, respectively. This implementation of OCC in conjunction with PUSCH repetition may allow PUSCH transmission with repetition without sacrificing resource efficiency, and the repetitive nature of uplink transmissions may allow the signaling configuration 200 to implement OCC without additional complexity at a receiver of the network entity 105-a or CDMA. In some cases, an OFDM grid structure, including different types of resource allocations and options for TBoMS, may support OCC using various methods.

In some cases, the UE 115-a may be configured with a set of rules for determining transmission occasions on which the UE 115-a may begin transmitting repetitions of a PUSCH transmission based on an RV sequence. For instance, the UE 115-a may be configured (e.g., via a configured grant (CG)) with a set of transmission occasions corresponding to a quantity K of repetitions of the PUSCH transmission. The UE 115-a may also be configured (e.g., via a higher layer parameter repK-RV) with one of a first RV sequence {0, 2, 3, 1}, a second RV sequence {0, 3, 0, 3}, or a third RV sequence {0, 0, 0, 0} to be applied to the quantity K of repetitions, and a parameter startingFromRVO may be set to “on,” indicating that the UE 115-a may start transmitting on transmission occasions associated with an expected RV of RV zero. The UE 115-a may determine an expected RV for an n^{th} transmission occasion of the set of transmission occasions as the i^{th} value of a configured RV sequence, where i is calculated as follows in Equation 1, where Nis a quantity of transmission occasions over which to perform rate matching in accordance with TBoMS and Φ is an offset with a value of zero if indexing of the transmission occasions begins at n=0 or a value of one if indexing of the transmission occasions begins at n=1:

$$i = mod ( \frac{n - mod ( n , N )}{N} - Φ , 4 ) + 1 \qquad ( 1 )$$

Without TBoMS, the set of rules may permit the UE 115-a to start transmitting the quantity K of repetitions on a first transmission occasion of a set of K transmission occasions if the UE 115-a is configured with the first RV sequence, on any transmission occasion of the set of K transmission occasions for with an expected RV is RV zero (e.g., RV=0) if the UE 115-a is configured with the second RV sequence, or any transmission occasion of the set of K transmission occasions except a last transmission occasion if the UE 115-a is configured with the third transmission occasion and K≥8. With TBoMS, the set of rules may permit the UE 115-a to start transmitting the quantity K of repetitions on a first transmission occasion of a set of N×K transmission occasions if the UE 115-a is configured with the first RV sequence or on any transmission occasion of the set of N×K transmission occasions for which an expected RV is the RV zero and mod(n, N)=0 (e.g., assuming Φ=0, otherwise if Φ=1 for transmission occasions for which mod(n, N)=1) if the UE 115-a is configured with the second RV sequence or the third RV sequence.

However, this set of rules may be incompatible with repetitions transmitted with OCC, for example for the quantity of repetitions 225-a. For instance, the UE 115-a may adjust an expected RV for an n^{th} transmission occasion of the set of transmission occasions based on an OCC factor M, where the expected RV is the i^{th} value of a configured RV sequence and i is calculated as follows in Equation 2:

$$i = mod ( \frac{n - mod ( n , M )}{M} - Φ , 4 ) + 1 \qquad ( 2 )$$

According to the set of rules, the UE 115-a may begin transmitting the quantity of repetitions 225-a, which may be associated with an OCC factor of two, in accordance with a table 220-a, which may indicate whether the UE 115-a is permitted to transmit or prohibited from transmitting on each transmission occasion of a set of M×K transmission occasions. For example, the UE 115-a may begin transmitting the quantity of repetitions 225-a on a sixth slot (e.g., n=6) of the set of transmission occasions based on the table 220-a. The UE 115-a may accordingly transmit the OCC group 215-a on the sixth slot and a seventh slot, and the UE 115-a may transmit a first slot of an OCC group 215-c, which may be identical to the OCC group 215-a (e.g., the OCC group 215-c may be a repetition of the OCC group 215-a), on an eighth slot of the set of transmission occasions. In such an example, the UE 115-a may refrain from transmitting a second slot of the OCC group 215-c, which may result in loss of orthogonality (e.g., break the OCC structure) between the OCC group 215-c and an OCC group 215 of the quantity of repetitions 225-b transmitted by the UE 115-b. This partial transmission of the OCC group 215-c and consequent loss of orthogonality may prevent the network entity 105-a from successfully decoding the OCC group 215-c and the OCC group transmitted by the UE 115-b.

Accordingly, the techniques described herein support a new set of rules for uplink transmissions of TBs with repetitions for systems using PUSCH with OCC. In some cases, the signaling configuration 200 may implement OCC in coverage-limited scenarios with several repetitions, and the new set of rules (e.g., new procedures) for transmission of TBs with repetitions for PUSCH using OCC may thus be beneficial in these cases. The new set of rules may increase reliability of OCC and may consequently support increased capacity of wireless communication systems that use OCC (e.g., compared to the original set of rules, which may break the OCC structure, thereby degrading performance).

The new set of rules may permit the UE 115-a to start transmitting the quantity of repetitions 225-a in accordance with a table 220-b. The new set of rules may implement a new constraint that the UE 115-a may begin transmitting the quantity of repetitions 225-a on transmission occasions on which an OCC group may begin (e.g., without partial transmission). For instance, this new constraint may be expressed as mod(n, M)=1 if Φ=1 or mod(n, M)=0 if Φ=0. The set of transmission occasions may be defined on a per OCC group basis, compared to a per transmission occasion basis with the original set of rules. For example, for slot-level OCC, an OCC group may be a quantity M of slots, where Mis the OCC factor.

Assuming transmission without TBoMS and the parameter startingFromRVO is set to “on,” the new set of rules may be as follows: the UE 115-a may start transmitting the quantity of repetitions 225-a on a first transmission occasion of a set of K transmission occasions if the UE 115-a is configured with the first RV sequence or on any transmission occasion of the set of K transmission occasions that is associated with an expected RV of RV zero (e.g., RV=0) and a beginning of an OCC group 215 if the UE 115-a is configured with the second RV sequence or the third RV sequence. In other words, assuming Φ=1, the new set of rules may permit the UE 115-a to start transmitting the quantity of repetitions 225-a on a first transmission occasion of the set of K transmission occasions if the UE 115-a is configured with the first RV sequence, on any transmission occasion of the set of K transmission occasions associated with an expected RV of RV zero and mod(n, M)=1 if the UE 115-a is configured with the second RV sequence, or any transmission occasion of the set of K transmission occasions for which mod(n, M)=1 except a last transmission occasion if the UE 115-a is configured with the third transmission occasion and K≥8.

The new set of rules and the table 220-b may thus prohibit the UE 115-a from beginning transmission of the quantity of repetitions 225-a on the sixth slot, thereby preventing partial transmission of the OCC group 215-c. In contrast, the table 220-b may permit the UE 115-a to begin transmitting the quantity of repetitions 225-a on a fifth slot of the set of transmission occasions, which may be associated with an expected RV of RV zero and a start of an OCC group. The new set of rules may restrict the UE 115-a to beginning transmission of the quantity of repetitions 225-a on a first slot and the fifth slot, compared to the first slot, a second slot, the fifth slot, and the sixth slot with the original set of rules illustrated by the table 220-a, in order to ensure complete transmission of OCC groups 215.

The network entity 105-a may receive the quantity of repetitions 225-a from the UE 115-a and the quantity of repetitions 225-b from the UE 115-b that are communicated beginning on an initial transmission occasion indicated as available in accordance with the new set of rules. The network entity 105-a may decode both the quantity of repetitions 225-a and the quantity of repetitions 225-b based on the new set of rules maintaining orthogonality (e.g., maintaining an OCC structure) between OCC groups 215 included in the quantity of repetitions 225-a and the quantity of repetitions 225-b. For instance, the network entity 105-a may decode orthogonal OCC groups 215 of the quantity of repetitions 225-a and the quantity of repetitions 225-b in accordance with the OCC codeword 210-a and the OCC codeword 210-b.

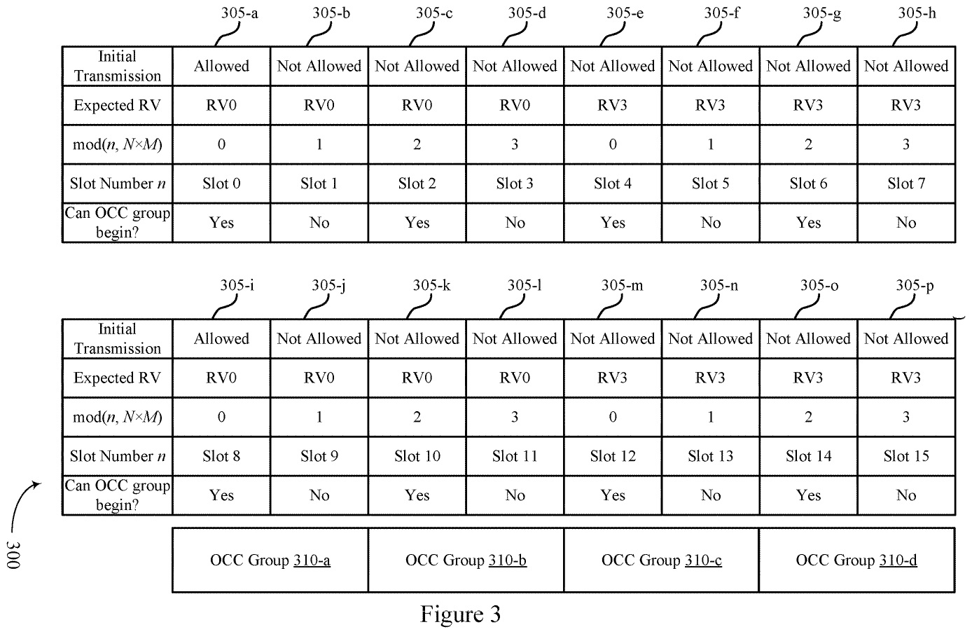

FIG. 3 shows an example of a table 300 that supports TB repetitions for PUSCH with OCC. In some examples, the table 300 may implement, or be implemented by, aspects of the wireless communication system 100 and the signaling configuration 200. For example, the table 300 may be used by a UE 115-a for determining transmission occasions on which the UE 115-a may begin transmission of a quantity of repetitions 225-a, as described with reference to FIG. 2.

In some examples, a UE 115 may transmit a quantity of repetitions of a TB for PUSCH in accordance with TBoMS. For example, the UE 115 may transmit each repetition of the quantity of repetitions across a quantity of rate-matched slots, where the quantity of rate-matched slots may be represented as a factor N. For instance, for a single repetition with N=2, the UE 115 may transmit a first portion of a quantity of data associated with the TB on a first slot and a second portion of the quantity of data that is rate-matched with the first portion on a second slot.

In some cases, the UE 115 may transmit the quantity of repetitions with OCC and TBoMS. In such cases, the UE 115 may transmit each repetition of the quantity of repetitions over N×M slots, where Mis the OCC factor. For example, for N=2 and M=2, the UE 115 may transmit a quantity of data corresponding to the TB over four slots. The UE 115 may transmit a first portion of the data scaled by a first value of an OCC codeword on a first slot, the first portion of the data scaled by a second value of the OCC codeword on a second slot, a second portion of the data scaled by the first value of the OCC codeword on a third slot, and a second portion of the data scaled by the second value of the OCC codeword on a fourth slot. In such an example, an OCC group 310 may include two slots, where a first OCC group 310 may include the first slot and the second slot, and a second OCC group 310 may include the third slot and the fourth slot.

The UE 115 may begin transmitting the quantity of repetitions of the TB on any transmission occasion (e.g., slot) indicated as available by the table 300. To illustrate, the UE 115 may be configured with a set of transmission occasions 305 for transmitting the quantity of repetitions and one of a first RV sequence {0, 2, 3, 1}, a second RV sequence {0, 3, 0, 3}, or a third RV sequence {0, 0, 0, 0}. The table 300 may indicate an expected RV associated with each transmission occasion 305. For an n^{th} slot of the set of transmission occasions 305, an expected RV may be the i^{th} value of a configured RV sequence, where i is calculated as follows in Equation 3, where Φ is an offset with a value of zero if indexing of the set of transmission occasions 305 begins at n=0 or a value of one if indexing of the set of slots begins at n=1:

$$i = mod ( \frac{n - mod ( n , N \times M )}{N \times M} - Φ , 4 ) + 1 \qquad ( 3 )$$

The table 300 may also indicate a value of mod(n, N×M) for each transmission occasion 305 and whether each transmission occasion 305 is associated with a beginning of an OCC group.

The table 300 may indicate whether a transmission occasion 305 is available for the UE 115 to begin transmitting the quantity of repetitions based on whether the transmission occasion 305 is associated with a beginning of an OCC group, the expected RV of the transmission occasion 305, and the value of mod(n, N×M) for the transmission occasion 305. For instance, if a parameter startingFromRVO is set to “on,” the UE 115 may begin transmitting on any transmission occasion 305 that is associated with an expected RV of RV zero (e.g., RV=0) and a beginning of an OCC group and for which mod(n, N×M)=0 (e.g., assuming Φ=0, otherwise if Φ=1 for transmission occasions for which mod(n, N×M)=1) if the configured RV sequence is the second RV sequence or the third RV sequence. Additionally, or alternatively, OCC may be disabled if M=1, and the UE 115 may begin transmitting on any transmission occasion associated with an expected RV of RV zero and for which mod(n, N)=0 if the configured RV sequence is the second RV sequence or the third RV sequence. If the configured RV sequence is the first RV sequence, the UE 115 may begin transmitting the quantity of repetitions on a first transmission occasion 305 (e.g., a transmission occasion 305-a) of the set of transmission occasions 305 (e.g., this may include cases in which OCC is disabled).

To illustrate, transmission occasion 305-a, transmission occasion 305-c, transmission occasion 305-e, transmission occasion 305-g, transmission occasion 305-i, transmission occasion 305-k, transmission occasion 305-m, and transmission occasion 305-o may correspond to a beginning of an OCC group, while the intervening (e.g., alternating) transmission occasions (e.g., transmission occasion 305-b, transmission occasion 305-d, transmission occasion 305-f, transmission occasion 305-h, transmission occasion 305-j, transmission occasion 305-l, transmission occasion 305-n, and transmission occasion 305-p) may not correspond to the beginning of an OCC group. Of the transmission occasions 305 corresponding to a beginning of an OCC group, the transmission occasion 305-a, the transmission occasion 305-c, the transmission occasion 305-i, and the transmission occasion 305-k may correspond to an expected RV of RV zero. Among these transmission occasions 305, the transmission occasion 305-a and the transmission occasion 305-i may have mod(n, N×M)=0, and accordingly the table 300 may permit the UE 115 to begin transmitting the quantity of repetitions on either the transmission occasion 305-a or the transmission occasion 305-i and may prohibit the UE 115 from beginning transmission on any of the other transmission occasions 305.

For instance, the UE 115 may begin transmitting on the transmission occasion 305-i. The UE 115 may transmit an OCC group 310-a across the transmission occasion 305-i and the transmission occasion 305-j, an OCC group 310-b across the transmission occasion 305-k and the transmission occasion 305-l, an OCC group 310-c across the transmission occasion 305-m and the transmission occasion 305-n, and an OCC group 310-d across the transmission occasion 305-o and the transmission occasion 305-p. The OCC group 310-a and the OCC group 310-c may include a first portion of the data corresponding to the TB (e.g., which has been rate matched across N slots according to the TBoMS, where N=2 in the illustrated example), and the OCC group 310-b and the OCC group 310-d may include a second portion of the data corresponding to the TB. The UE 115 beginning transmission on one of the transmission occasion 305-a or the transmission occasion 305-i in accordance with the table 300 may ensure complete transmission of both a first OCC group 310 corresponding to the first portion of the data and a second OCC group 310 corresponding to the second portion of the data (e.g., both the OCC group 310-a and the OCC group 310-b, both the OCC group 310-c and the OCC group 310-d), thus maintaining orthogonality between OCC groups 310 by the UE 115 and orthogonal transmissions by other UEs 115 and thus allowing a receiving network entity 105 to successfully decode the OCC group 310 and the orthogonal transmissions. The UE 115 beginning transmitting in accordance with table 300 may also improve robustness of repetitions of the TB by ensuring each repetition includes all portions of the data (e.g., both the first portion of the data and the second portion of the data). The UE 115 transmitting a TB for PUSCH with repetition, OCC, and TBoMS may allow a wireless communication system to simultaneously realize benefits of PUSCH with repetition, OCC, and TBoMS, such as improved signal quality (e.g., SNR), coverage enhancement, increased system capacity, and increased flexibility in transmission parameters.

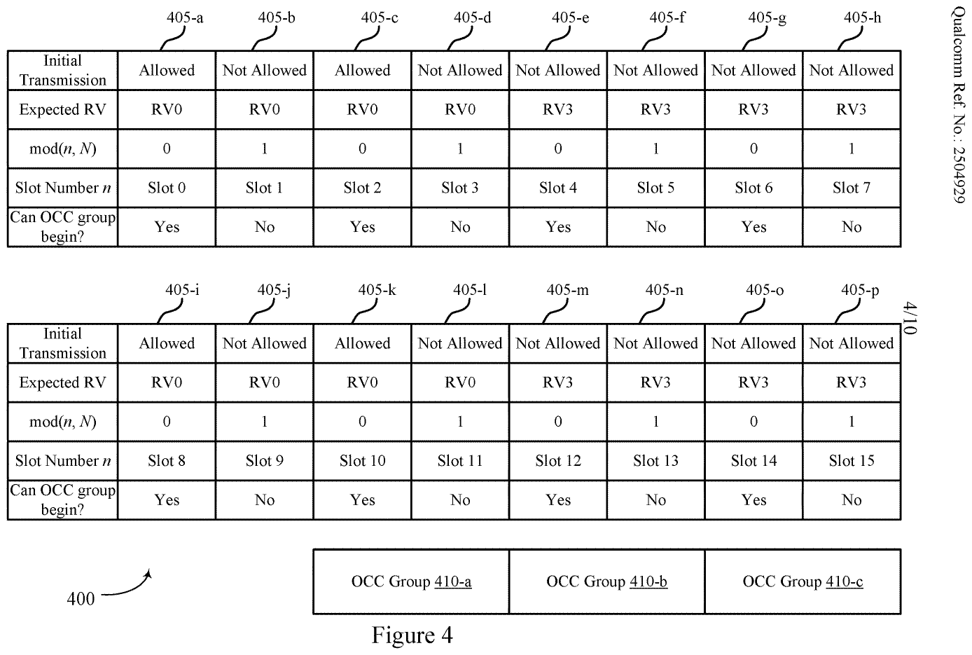

FIG. 4 shows an example of a table 400 that supports TB repetitions for PUSCH with OCC. In some examples, the table 400 may implement, or be implemented by, aspects of the wireless communication system 100, the signaling configuration 200, and the table 300. For example, the table 400 may be used by a UE 115-a for determining transmission occasions on which the UE 115-a may begin transmission of a quantity of repetitions 225-a, as described with reference to FIG. 2.

In some examples, a UE 115 may transmit a quantity of repetitions of a TB for PUSCH in accordance with TBoMS. For example, the UE 115 may transmit each repetition of the quantity of repetitions across a quantity of rate-matched slots, where the quantity of rate-matched slots may be represented as a factor N. For instance, for a single repetition with N=2, the UE 115 may transmit a first portion of a quantity of data associated with the TB on a first slot and a second portion of the quantity of data that is rate-matched with the first portion on a second slot.

In some cases, the UE 115 may transmit the quantity of repetitions with OCC and TBoMS. In such cases, the UE 115 may transmit each repetition of the quantity of repetitions over N×M slots, where Mis the OCC factor. For example, for N=2 and M=2, the UE 115 may transmit a quantity of data corresponding to the TB over four slots. The UE 115 may transmit a first portion of the data (e.g., which has been rate matched across N slots according to the TBoMS, where N=2 in the illustrated example) scaled by a first value of an OCC codeword on a first slot, the first portion of the data scaled by a second value of the OCC codeword on a second slot, a second portion of the data scaled by the first value of the OCC codeword on a third slot, and a second portion of the data scaled by the second value of the OCC codeword on a fourth slot. An OCC group 410 may include two slots, where a first OCC group 410 may include the first slot and the second slot, and a second OCC group 410 may include the third slot and the fourth slot.

The UE 115 may begin transmitting the quantity of repetitions of the TB on any transmission occasion (e.g., slot) indicated as available by the table 400. To illustrate, the UE 115 may be configured with a set of transmission occasions 405 for transmitting the quantity of repetitions and one of a first RV sequence {0, 2, 3, 1}, a second RV sequence {0, 3, 0, 3}, or a third RV sequence {0, 0, 0, 0}. The table 400 may indicate an expected RV associated with an n^{th} transmission occasion 405, which may be calculated in accordance with Equation 3, as described with reference to FIG. 3. The table 400 may also indicate a value of mod(n, N) for each transmission occasion 405 and whether each transmission occasion 405 is associated with a beginning of an OCC group.

The table 400 may indicate whether a transmission occasion 405 is available for the UE 115 to begin transmitting the quantity of repetitions based on whether the transmission occasion 405 is associated with a beginning of an OCC group, the expected RV of the transmission occasion 405, and the value of mod(n, N) for the transmission occasion 405. For instance, if a parameter startingFromRVO is set to “on,” the UE 115 may begin transmitting on any transmission occasion 405 that is associated with an expected RV of RV zero (e.g., RV=0) and a beginning of an OCC group and for which mod(n, N)=0 (e.g., e.g., assuming Φ=0, otherwise if Φ=1 for transmission occasions for which mod(n, N)=1) if the configured RV sequence is the second RV sequence or the third RV sequence. Additionally, or alternatively, OCC may be disabled if M=1, and the UE 115 may begin transmitting on any transmission occasion associated with an expected RV of RV zero and for which mod(n, N)=0 if the configured RV sequence is the second RV sequence or the third RV sequence. If the configured RV sequence is the first RV sequence, the UE 115 may begin transmitting the quantity of repetitions on a first transmission occasion 405 (e.g., a transmission occasion 405-a) of the set of transmission occasion 405 (e.g., this may include cases in which OCC is disabled).

To illustrate, transmission occasion 405-a, transmission occasion 405-c, transmission occasion 405-e, transmission occasion 405-g, transmission occasion 405-i, transmission occasion 405-k, transmission occasion 405-m, and transmission occasion 405-o may correspond to a beginning of an OCC group, while the intervening (e.g., alternating) transmission occasions (e.g., transmission occasion 405-b, transmission occasion 405-d, transmission occasion 405-f, transmission occasion 405-h, transmission occasion 405-j, transmission occasion 405-l, transmission occasion 405-n, and transmission occasion 405-p) may not correspond to the beginning of an OCC group. Of the transmission occasions 405 associated with a beginning of an OCC group, the transmission occasion 405-a, the transmission occasion 405-c, the transmission occasion 405-i, and the transmission occasion 405-k may be associated with an expected RV of RV zero. Each of the transmission occasion 405-a, the transmission occasion 405-c, the transmission occasion 405-i, and the transmission occasion 405-k may have mod(n, N)=0, and accordingly the table 400 may permit the UE 115 to begin transmitting the quantity of repetitions on any of the transmission occasion 405-a, the transmission occasion 405-c, the transmission occasion 405-i, or the transmission occasion 405-k and may prohibit the UE 115 from beginning transmission on any of the other transmission occasion 405.

For instance, the UE 115 may begin transmitting on the transmission occasion 405-k. The UE 115 may transmit an OCC group 410-a across the transmission occasion 405-k and the transmission occasion 405-l, an OCC group 410-b across the transmission occasion 405-m and the transmission occasion 405-n, and an OCC group 410-c across the transmission occasion 405-o and the transmission occasion 405-p. The OCC group 410-a and the OCC group 410-c may include a first portion of the data corresponding to the TB, and the OCC group 410-b may include a second portion of the data corresponding to the TB. The UE 115 beginning transmission on one of the transmission occasion 405-a, the transmission occasion 405-c, the transmission occasion 405-i, or the transmission occasion 405-k in accordance with the table 400 may ensure complete transmission of an OCC group 410 but may in some cases (e.g., the transmission occasion 405-c and the transmission occasion 405-k) allow transmission of an OCC group 410 corresponding to a first portion of the quantity of data to be transmitted without a complementary OCC group 410 corresponding to a second portion of the quantity of data. The table 400 may thus permit more flexibility relative to the table 300 (e.g., in contrast, the table 300 may support more robust transmissions relative to the table 400) while still maintaining the OCC structure to ensure that the network entity 105 may decode the OCC groups 410 and orthogonal transmissions by other UEs 115. The UE 115 transmitting a TB for PUSCH with repetition, OCC, and TBoMS may allow a wireless communication system to simultaneously realize benefits of PUSCH with repetition, OCC, and TBoMS, such as improved signal quality (e.g., SNR), coverage enhancement, increased system capacity, and increased flexibility in transmission parameters.

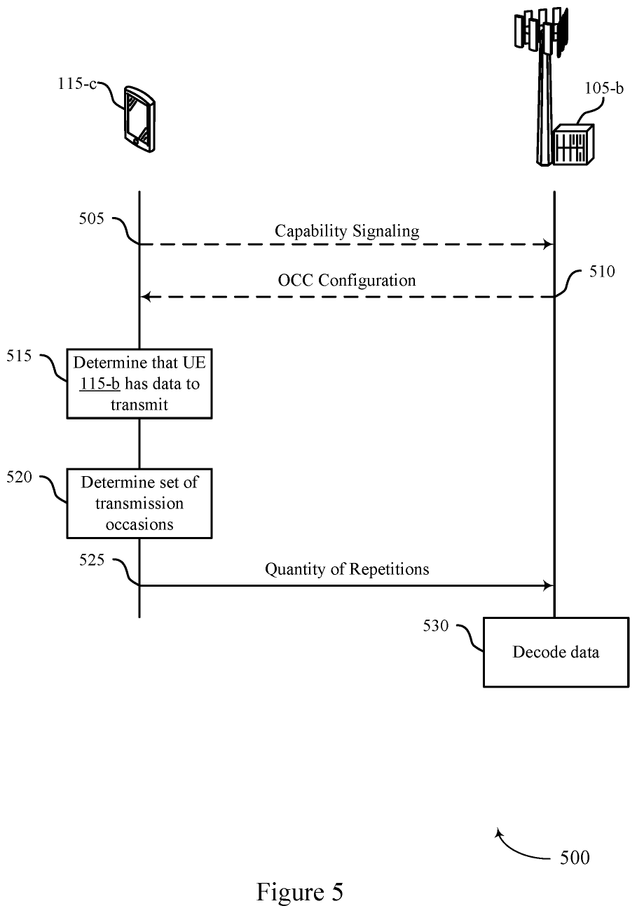

FIG. 5 shows an example of a process flow 500 that supports TB repetitions for PUSCH with OCC. In some aspects, the process flow 500 may implement or be implemented to realize aspects of the wireless communication system 100, the signaling configuration 200, the table 300, and the table 400. For example, the process flow 500 may include a UE 115-c and a network entity 105-b (e.g., the network entity 105-b may be associated with an NTN), which may be examples of UEs 115, network entities 105, or other wireless communication devices as described with reference to FIGS. 1 and 2.

In the following description of the process flow 500, the operations between the UE 115-c and the network entity 105-b may occur in a different order than the example order shown and, in some examples, may be performed by one or more different devices other than those shown as examples. Some operations may also be omitted from the process flow 500, and other operations may be added to the process flow 500. Further, although some operations or signaling may be shown to occur at different times for discussion purposes, these operations may actually occur at the same time.

At 505, the UE 115-c may transmit (e.g., and the network entity 105-b may receive) capability signaling indicating that the UE 115-c supports OCC. In some aspects, the capability signaling may depend on phase coherence capabilities associated with the UE 115-c. Based on the UE 115-c supporting OCC, the UE 115-c may transmit PUSCH repetitions in accordance with the techniques described herein (e.g., as opposed to the original set of rules as described with reference to FIG. 2).

At 510, the network entity 105-b may transmit (e.g., and the UE 115-c may receive) control signaling indicating an OCC configuration. The OCC configuration may include an OCC factor and an OCC codeword to be applied by the UE 115-c to PUSCH transmissions. In some cases, the network entity 105-b may transmit the control signaling via RRC signaling, a MAC control element (CE), or DCI.

At 515, the UE 115-c may determine that the UE 115-c has data to transmit across a quantity of repetitions. For instance, the data may be associated with a TB that the UE 115-c may transmit via PUSCH across the quantity of repetitions.

At 520, the UE 115-c may determine a set of transmission occasions to which the UE 115-c may apply an RV sequence associated with the quantity of repetitions. For instance, the RV sequence may include, in sequence, RV zero, RV three, RV zero, and RV three (e.g., {0, 3, 0, 3}), or the RV sequence may include, in sequence, RV zero, RV zero, RV zero, and RV zero (e.g., {0, 0, 0, 0}). In some aspects, the UE 115-c may determine an expected RV associated with each transmission occasion of the set of transmission occasions based on the RV sequence associated with the quantity of repetitions.

At 525, the UE 115-c may transmit (e.g., and the network entity 105-b may receive) the quantity of repetitions starting on a transmission occasion of the set of transmission occasions that is available for the UE 115-c to start transmitting the quantity of repetitions. The transmission occasion may be available based on the RV sequence and in accordance with the OCC factor. In some aspects, the UE 115-c may transmit the quantity of repetitions based on applying the OCC codeword to the data. For instance, the UE 115-c may spread each repetition across a plurality of transmission occasions in accordance with the OCC factor and scale the data by a corresponding value of the OCC codeword for each transmission occasion of the plurality of transmission occasions.

In some examples, the UE 115-c may transmit (e.g., and the network entity 105-b may receive), for each repetition of the quantity of repetitions, a second quantity of messages corresponding to the OCC factor, where each message of the second quantity of messages is transmitted on a single transmission occasion of the set of transmission occasions. (e.g., the UE 115-c may transmit the quantity of repetitions without TBoMS). For example, each message of the second quantity of messages may include the data scaled by a corresponding scalar value of the OCC codeword. The UE 115-c may start transmitting the quantity of repetitions on the transmission occasion based on an expected RV of the transmission occasion, which may be calculated in accordance with Equation 2, and the OCC factor. In some cases, the transmission occasion may be available based on an expected RV corresponding to the transmission occasion being the RV zero in accordance with the RV sequence and the transmission occasion corresponding to a beginning of an OCC group in accordance with the OCC factor. Additionally, or alternatively, the transmission occasion may be available based on the expected RV corresponding to the transmission occasion being the RV zero in accordance with the RV sequence and a remainder of dividing a first index value (e.g., n) corresponding to the transmission occasion by the OCC factor. For instance, the transmission occasion may be available if the remainder is zero (e.g., mod(n, M)=0) if indexing of the set of transmission occasions begins with n=0 (e.g., assuming Φ=0), or if the remainder is one (e.g., mod(n, M)=1) if indexing of the set of transmission occasions begins with n=1 (e.g., assuming Φ=1).

In some cases, the UE 115-c may transmit each repetition of the quantity of repetitions over a second quantity of transmission occasions, where the second quantity of transmission occasions may be a product of the OCC factor (e.g., M) and a factor (e.g., N) indicating a third quantity of transmission occasions over which to perform rate matching for respective RVs corresponding to each repetition (e.g., the UE 115-c may implement TBoMS for transmitting the quantity of repetitions, and the UE 115-c may transmit each repetition over N×M transmission occasions). For instance, the UE 115-c may divide the data into N portions and transmit an OCC group corresponding to each of the N portions, where each OCC group includes M messages. For an OCC group corresponding to a first portion of the data, the OCC group may include M messages, where each message includes the first portion of the data scaled by a respective value of the OCC codeword.

In such cases, an expected RV corresponding to the transmission occasion may be based on a first index value (e.g., n) corresponding to the transmission occasion, the OCC factor, and the factor indicating the third quantity of transmission occasions. For example, the expected RV may be calculated in accordance with Equation 3. In some examples, the transmission occasion may be available based on the transmission occasion corresponding to a beginning of an OCC group in accordance with the OCC factor, the expected RV being RV zero in accordance with the RV sequence, and a remainder of dividing the first index value by the product (e.g., mod(n, N×M)=0 if indexing of the set of transmission occasions begins at zero or mod(n, N×M)=1 if indexing of the set of transmission occasions begins at one). Additionally, or alternatively, the transmission occasion may be available based on the transmission occasion corresponding to a beginning of an OCC group in accordance with the OCC factor, the expected RV being RV zero in accordance with the RV sequence, and a remainder of dividing the first index value by the factor (e.g., mod(n, N)=0 if indexing of the set of transmission occasions begins at zero or mod(n, N)=1 if indexing of the set of transmission occasions begins at one).

At 530, the network entity 105-b may decode the data (e.g., TB). In some cases, a second UE 115 may transmit, at 525, a second quantity of repetitions (e.g., which may be the same or different than the quantity of repetitions transmitted by UE 115-c) starting on a transmission occasion (e.g., the same initial transmission occasion used by UE 115-c, or a different transmission occasion) of the set of transmission occasions that is available for the second UE 115 to start transmitting the second quantity of repetitions. The second UE 115 may apply a different OCC codeword to repetitions of the second quantity of repetitions, and the network entity 105-b may be able to decode the data from the UE 115-c and from the second UE 115 using the different OCC codewords based on the application of rules maintaining orthogonality (e.g., maintaining an OCC structure) between OCC groups included in the quantity of repetitions transmitted by the UE 115-c and the second quantity of repetitions transmitted by the second UE 115.

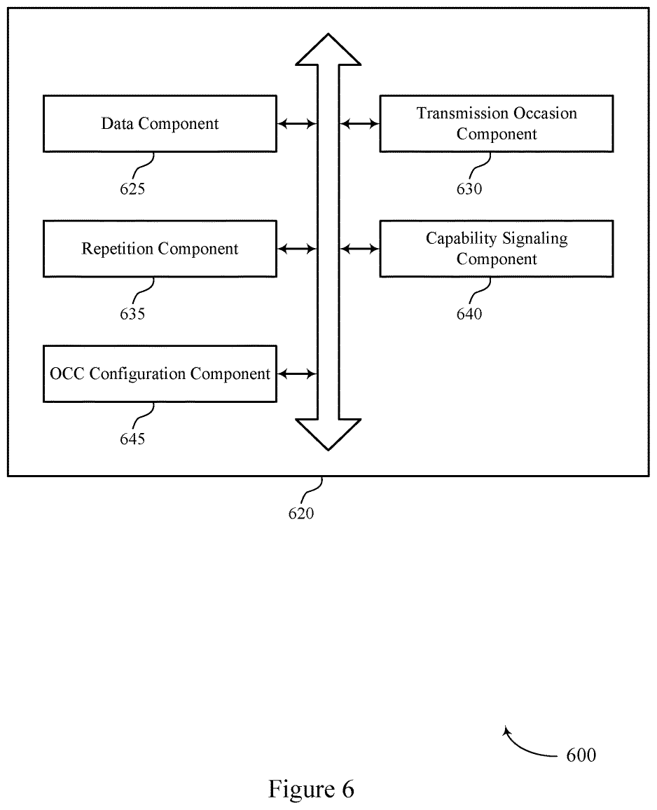

FIG. 6 shows an example 600 of a processing system 620 that supports TB repetitions for PUSCH with OCC. A processing system 620 may be an example of a processing system 140 (such as of a UE 115) and may include a data component 625, a transmission occasion component 630, a repetition component 635, a capability signaling component 640, a OCC configuration component 645, or any combination thereof. A processing system 620, or various component thereof, may be an example of means for performing (such as a means for causing a UE 115 to perform) various techniques described herein.

The data component 625 may be configured to cause the UE 115 to determine that the UE has data to transmit across a quantity of repetitions using OCC. The transmission occasion component 630 may be configured to cause the UE 115 to determine a set of transmission occasions to which the UE applies an RV sequence associated with the quantity of repetitions. The repetition component 635 may be configured to cause the UE 115 to transmit the quantity of repetitions starting on an initial transmission occasion of the set of transmission occasions, where the initial transmission occasion is available for the UE to start transmitting the quantity of repetitions based on the RV sequence and in accordance with an OCC factor.

In some examples, the capability signaling component 640 may be configured to cause the UE 115 to transmit capability signaling indicating that the UE supports transmissions with OCCs, where transmitting the quantity of repetitions is in accordance with the UE supporting the transmissions with OCCs.

In some examples, the OCC configuration component 645 may be configured to cause the UE 115 to receive control signaling indicating an OCC configuration, where the OCC configuration includes the OCC factor and an OCC codeword, and where transmitting the quantity of repetitions is based on applying the OCC codeword to the data.

In some examples, to support transmitting the quantity of repetitions, the repetition component 635 may be configured to cause the UE 115 to transmit, for each repetition of the quantity of repetitions, a second quantity of messages corresponding to the OCC factor, where each message of the second quantity of messages is transmitted on a single transmission occasion of the set of transmission occasions.

In some examples, the initial transmission occasion is available based on an expected RV corresponding to the initial transmission occasion being RV zero in accordance with the RV sequence and the initial transmission occasion corresponding to a beginning of an OCC group in accordance with the OCC factor.

In some examples, the initial transmission occasion corresponds to a first index value. In some examples, the initial transmission occasion is available based on an expected RV corresponding to the initial transmission occasion being RV zero in accordance with the RV sequence and a remainder of dividing the first index value by the OCC factor.

In some examples, to support transmitting the quantity of repetitions, the repetition component 635 may be configured to cause the UE 115 to transmit each repetition of the quantity of repetitions over a second quantity of transmission occasions, where the second quantity of transmission occasions is a product of the OCC factor and a factor indicating a third quantity of transmission occasions over which to perform rate matching for respective RVs corresponding to the each repetition.

In some examples, an expected redundancy version corresponding to the initial transmission occasion is calculated based on a first index value corresponding to the initial transmission occasion, the OCC factor, and the factor indicating the third quantity of transmission occasions.

In some examples, the initial transmission occasion corresponds to a first index value. In some examples, the initial transmission occasion is available based on the initial transmission occasion corresponding to a beginning of an OCC group in accordance with the OCC factor, an expected RV corresponding to the initial transmission occasion being RV zero in accordance with the RV sequence, and a remainder of dividing the first index value by the product.

In some examples, the initial transmission occasion corresponds to a first index value. In some examples, the initial transmission occasion is available based on the initial transmission occasion corresponding to a beginning of an OCC group in accordance with the OCC factor, an expected RV corresponding to the initial transmission occasion being RV zero in accordance with the RV sequence, and a remainder of dividing the first index value by the factor.

In some examples, the RV sequence includes, in sequence, RV zero, RV three, the RV zero, and the RV three.

In some examples, the RV sequence includes, in sequence, RV zero, the RV zero, the RV zero, and the RV zero.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for improved communication reliability, more efficient utilization of communication resources, improved coordination between devices, and improved utilization of processing capability.

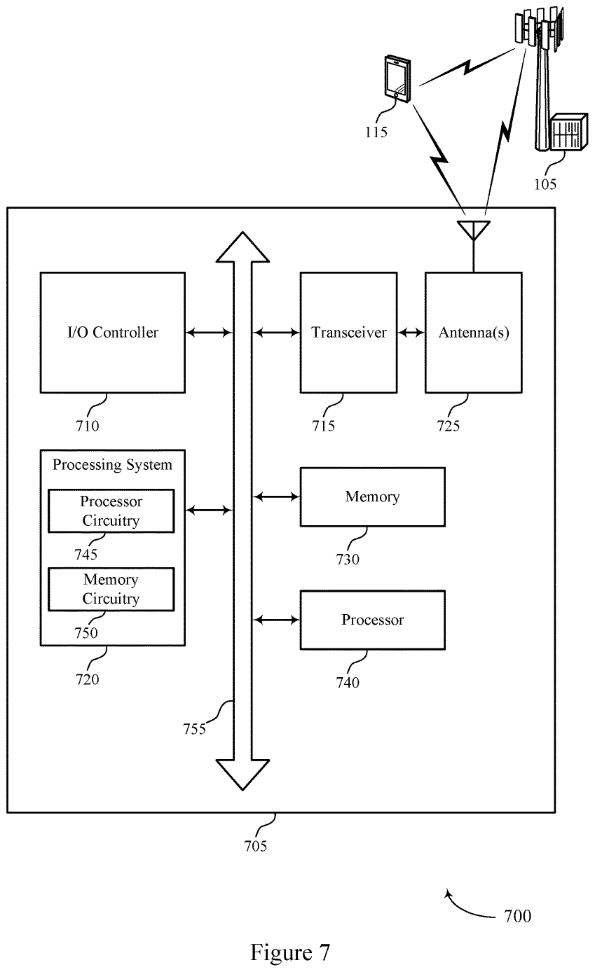

FIG. 7 shows an example of a system 700 including a device 705 that supports TB repetitions for PUSCH with OCCs. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support TB repetitions for PUSCH with OCCs. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, more efficient utilization of communication resources, improved coordination between devices, and improved utilization of processing capability.

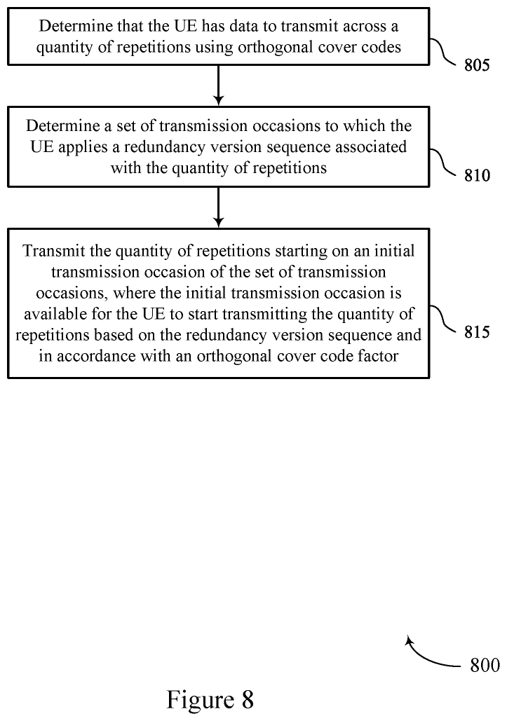

FIG. 8 shows an example of a method 800 that supports TB repetitions for PUSCH with OCCs. Operations of the method 800 may be performed by a UE or its components (such as using a processing system configured to cause the UE 115 to perform one or more of the operations) as described herein.

At 805, the method may include determining that the UE has data to transmit across a quantity of repetitions using OCCs. In some examples, aspects of the operations of 805 may be performed by a data component 625.

At 810, the method may include determining a set of transmission occasions to which the UE applies an RV sequence associated with the quantity of repetitions. In some examples, aspects of the operations of 810 may be performed by a transmission occasion component 630.

At 815, the method may include transmitting the quantity of repetitions starting on an initial transmission occasion of the set of transmission occasions, where the initial transmission occasion is available for the UE to start transmitting the quantity of repetitions based on the RV sequence and in accordance with an OCC factor. In some examples, aspects of the operations of 815 may be performed by a repetition component 635.

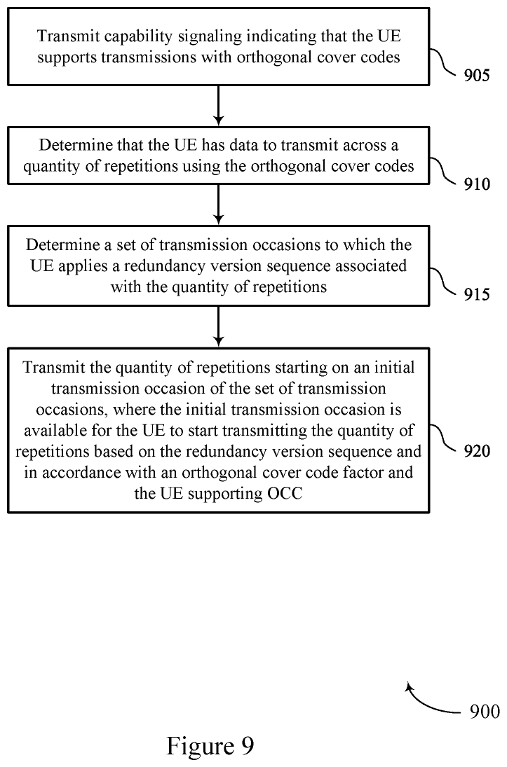

FIG. 9 shows an example of a method 900 that supports TB repetitions for PUSCH with OCCs. Operations of the method 900 may be performed by a UE or its components (such as using a processing system configured to cause the UE 115 to perform one or more of the operations) as described herein.

At 905, the method may include transmitting capability signaling indicating that the UE supports transmissions with OCCs. In some examples, aspects of the operations of 905 may be performed by a capability signaling component 640.

At 910, the method may include determining that the UE has data to transmit across a quantity of repetitions using OCCs. In some examples, aspects of the operations of 910 may be performed by a data component 625.

At 915, the method may include determining a set of transmission occasions to which the UE applies an RV sequence associated with the quantity of repetitions. In some examples, aspects of the operations of 915 may be performed by a transmission occasion component 630.

At 920, the method may include transmitting the quantity of repetitions starting on an initial transmission occasion of the set of transmission occasions, where the initial transmission occasion is available for the UE to start transmitting the quantity of repetitions based on the RV sequence and in accordance with an OCC factor and the UE supporting OCCs. In some examples, aspects of the operations of 920 may be performed by a repetition component 635.

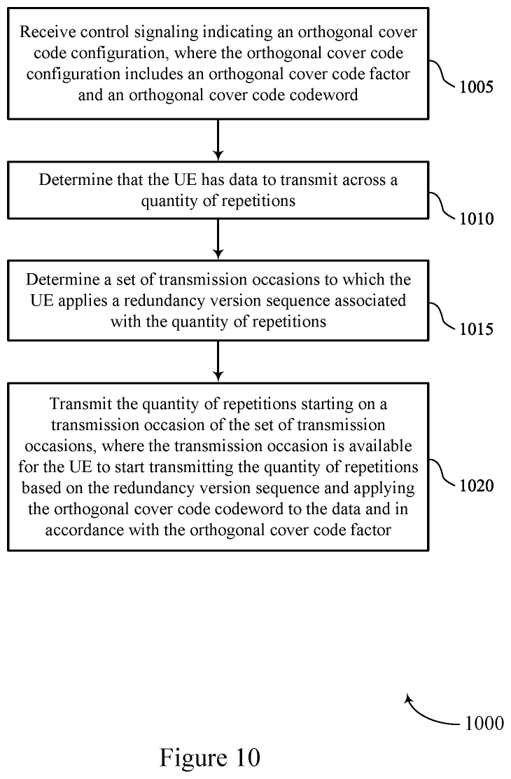

FIG. 10 shows an example of a method 1000 that supports TB repetitions for PUSCH with OCCs. Operations of the method 1000 may be performed by a UE or its components (such as using a processing system configured to cause the UE 115 to perform one or more of the operations) as described herein.

At 1005, the method may include receiving control signaling indicating an OCC configuration, where the OCC configuration includes an OCC factor and an OCC codeword. In some examples, aspects of the operations of 1005 may be performed by a OCC configuration component 645.

At 1010, the method may include determining that the UE has data to transmit across a quantity of repetitions using OCCs. In some examples, aspects of the operations of 1010 may be performed by a data component 625.

At 1015, the method may include determining a set of transmission occasions to which the UE applies an RV sequence associated with the quantity of repetitions. In some examples, aspects of the operations of 1015 may be performed by a transmission occasion component 630.

At 1020, the method may include transmitting the quantity of repetitions starting on an initial transmission occasion of the set of transmission occasions, where the initial transmission occasion is available for the UE to start transmitting the quantity of repetitions based on the RV sequence and applying the OCC codeword to the data and in accordance with an orthogonal cover code factor. In some examples, aspects of the operations of 1020 may be performed by a repetition component 635.

Implementation examples are described in the following numbered clauses:

Aspect 1: A method for wireless communication by a UE, comprising: determining that the UE has data to transmit across a quantity of repetitions using orthogonal cover codes; determining a set of transmission occasions to which the UE applies an RV sequence associated with the quantity of repetitions; and transmitting the quantity of repetitions starting on an initial transmission occasion of the set of transmission occasions, wherein the initial transmission occasion is available for the UE to start transmitting the quantity of repetitions based at least in part on the RV sequence and in accordance with an OCC factor.

Aspect 2: The method of aspect 1, further comprising: transmitting capability signaling indicating that the UE supports transmissions with OCCs, wherein transmitting the quantity of repetitions is in accordance with the UE supporting the transmissions with OCCs.

Aspect 3: The method of any of aspects 1 through 2, further comprising: receiving control signaling indicating an OCC configuration, wherein the OCC configuration comprises the OCC factor and an OCC codeword, and wherein transmitting the quantity of repetitions is based at least in part on applying the OCC codeword to the data.

Aspect 4: The method of any of aspects 1 through 3, wherein transmitting the quantity of repetitions comprises: transmitting, for each repetition of the quantity of repetitions, a second quantity of messages corresponding to the OCC factor, wherein each message of the second quantity of messages is transmitted on a single transmission occasion of the set of transmission occasions.

Aspect 5: The method of aspect 4, wherein the initial transmission occasion is available based at least in part on an expected RV corresponding to the initial transmission occasion being RV zero in accordance with the RV sequence and the initial transmission occasion corresponding to a beginning of an OCC group in accordance with the OCC factor.

Aspect 6: The method of any of aspects 4 through 5, wherein the initial transmission occasion corresponds to a first index value, and the initial transmission occasion is available based at least in part on an expected RV corresponding to the initial transmission occasion being RV zero in accordance with the RV sequence and a remainder of dividing the first index value by the OCC factor.

Aspect 7: The method of any of aspects 1 through 6, wherein transmitting the quantity of repetitions comprises: transmitting each repetition of the quantity of repetitions over a second quantity of transmission occasions, wherein the second quantity of transmission occasions is a product of the OCC factor and a factor indicating a third quantity of transmission occasions over which to perform rate matching for respective RVs corresponding to the each repetition.

Aspect 8: The method of aspect 7, wherein an expected RV corresponding to the initial transmission occasion is calculated based at least in part on a first index value corresponding to the initial transmission occasion, the OCC factor, and the factor indicating the third quantity of transmission occasions.

Aspect 9: The method of any of aspects 7 through 8, wherein the initial transmission occasion corresponds to a first index value, and the initial transmission occasion is available based at least in part on the initial transmission occasion corresponding to a beginning of an OCC group in accordance with the OCC factor, an expected RV corresponding to the initial transmission occasion being RV zero in accordance with the RV sequence, and a remainder of dividing the first index value by the product.

Aspect 10: The method of any of aspects 7 through 9, wherein the initial transmission occasion corresponds to a first index value, and the initial transmission occasion is available based at least in part on the initial transmission occasion corresponding to a beginning of an OCC group in accordance with the OCC factor, an expected RV corresponding to the initial transmission occasion being RV zero in accordance with the RV sequence, and a remainder of dividing the first index value by the factor.

Aspect 11: The method of any of aspects 1 through 10, wherein the RV sequence comprises, in sequence, RV zero, RV three, the RV zero, and the RV three.

Aspect 12: The method of any of aspects 1 through 11, wherein the RV sequence comprises, in sequence, RV zero, the RV zero, the RV zero, and the RV zero.

Aspect 13: A UE for wireless communication, comprising a processing system that includes processor circuitry and memory circuitry that stores code, the processing system configured to cause the UE to perform a method of any of aspects 1 through 12.

Aspect 14: A UE for wireless communication, comprising at least one means for performing a method of any of aspects 1 through 12.

Aspect 15: A non-transitory computer-readable medium storing code for wireless communication, the code comprising instructions executable by one or more processors to perform a method of any of aspects 1 through 12.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
determine that the UE has data to transmit across a quantity of repetitions using orthogonal cover codes;
determine a set of transmission occasions to which the UE applies a redundancy version sequence associated with the quantity of repetitions; and
transmit the quantity of repetitions starting on an initial transmission occasion of the set of transmission occasions, wherein the initial transmission occasion is available for the UE to start transmitting the quantity of repetitions based at least in part on the redundancy version sequence and in accordance with an orthogonal cover code factor.

2. The UE of claim 1, wherein, to transmit the quantity of repetitions, the one or more processors are individually or collectively operable to execute the code to cause the UE to:
transmit, for each repetition of the quantity of repetitions, a second quantity of messages corresponding to the orthogonal cover code factor, wherein each message of the second quantity of messages is transmitted on a single transmission occasion of the set of transmission occasions.

3. The UE of claim 2, wherein the initial transmission occasion is available based at least in part on an expected redundancy version corresponding to the initial transmission occasion being redundancy version zero in accordance with the redundancy version sequence and the initial transmission occasion corresponding to a beginning of an orthogonal cover code group in accordance with the orthogonal cover code factor.

4. The UE of claim 2, wherein the initial transmission occasion corresponds to a first index value, and wherein the initial transmission occasion is available based at least in part on an expected redundancy version corresponding to the initial transmission occasion being redundancy version zero in accordance with the redundancy version sequence and a remainder of dividing the first index value by the orthogonal cover code factor.

5. The UE of claim 1, wherein the one or more processors are individually or collectively further operable to execute the code to cause the UE to:
transmit capability signaling indicating that the UE supports transmissions with the orthogonal cover codes, wherein transmitting the quantity of repetitions is in accordance with the UE supporting the transmissions with the orthogonal cover codes.

6. The UE of claim 1, wherein the one or more processors are individually or collectively further operable to execute the code to cause the UE to:
receive control signaling indicating an orthogonal cover code configuration, wherein the orthogonal cover code configuration comprises the orthogonal cover code factor and an orthogonal cover code codeword, and wherein transmitting the quantity of repetitions is based at least in part on applying the orthogonal cover code codeword to the data.

7. The UE of claim 1, wherein, to transmit the quantity of repetitions, the one or more processors are individually or collectively operable to execute the code to cause the UE to:
transmit each repetition of the quantity of repetitions over a second quantity of transmission occasions, wherein the second quantity of transmission occasions is a product of the orthogonal cover code factor and a factor indicating a third quantity of transmission occasions over which to perform rate matching for respective redundancy versions corresponding to each repetition.

8. The UE of claim 7, wherein an expected redundancy version corresponding to the initial transmission occasion is calculated based at least in part on a first index value corresponding to the initial transmission occasion, the orthogonal cover code factor, and the factor indicating the third quantity of transmission occasions.

9. The UE of claim 7, wherein the initial transmission occasion corresponds to a first index value, and wherein the initial transmission occasion is available based at least in part on the initial transmission occasion corresponding to a beginning of an orthogonal cover code group in accordance with the orthogonal cover code factor, an expected redundancy version corresponding to the initial transmission occasion being redundancy version zero in accordance with the redundancy version sequence, and a remainder of dividing the first index value by the product.

10. The UE of claim 7, wherein the initial transmission occasion corresponds to a first index value, and wherein the initial transmission occasion is available based at least in part on the initial transmission occasion corresponding to a beginning of an orthogonal cover code group in accordance with the orthogonal cover code factor, an expected redundancy version corresponding to the initial transmission occasion being redundancy version zero in accordance with the redundancy version sequence, and a remainder of dividing the first index value by the factor.

11. The UE of claim 1, wherein the redundancy version sequence comprises, in sequence, redundancy version zero, redundancy version three, the redundancy version zero, and the redundancy version three.

12. The UE of claim 1, wherein the redundancy version sequence comprises, in sequence, redundancy version zero, the redundancy version zero, the redundancy version zero, and the redundancy version zero.

13. A method for wireless communication by a user equipment (UE), comprising:
determining that the UE has data to transmit across a quantity of repetitions using orthogonal cover codes;
determining a set of transmission occasions to which the UE applies a redundancy version sequence associated with the quantity of repetitions; and
transmitting the quantity of repetitions starting on an initial transmission occasion of the set of transmission occasions, wherein the initial transmission occasion is available for the UE to start transmitting the quantity of repetitions based at least in part on the redundancy version sequence and in accordance with an orthogonal cover code factor.

14. The method of claim 13, wherein transmitting the quantity of repetitions comprises:
transmitting, for each repetition of the quantity of repetitions, a second quantity of messages corresponding to the orthogonal cover code factor, wherein each message of the second quantity of messages is transmitted on a single transmission occasion of the set of transmission occasions.

15. The method of claim 14, wherein the initial transmission occasion is available based at least in part on an expected redundancy version corresponding to the initial transmission occasion being redundancy version zero in accordance with the redundancy version sequence and the initial transmission occasion corresponding to a beginning of an orthogonal cover code group in accordance with the orthogonal cover code factor.

16. The method of claim 14, wherein the initial transmission occasion corresponds to a first index value, and wherein the initial transmission occasion is available based at least in part on an expected redundancy version corresponding to the initial transmission occasion being redundancy version zero in accordance with the redundancy version sequence and a remainder of dividing the first index value by the orthogonal cover code factor.

17. The method of claim 13, further comprising:
transmitting capability signaling indicating that the UE supports transmissions with the orthogonal cover codes, wherein transmitting the quantity of repetitions is in accordance with the UE supporting the transmissions with the orthogonal cover codes.

18. The method of claim 13, further comprising:
receiving control signaling indicating an orthogonal cover code configuration, wherein the orthogonal cover code configuration comprises the orthogonal cover code factor and an orthogonal cover code codeword, and wherein transmitting the quantity of repetitions is based at least in part on applying the orthogonal cover code codeword to the data.

19. The method of claim 13, wherein transmitting the quantity of repetitions comprises:
transmitting each repetition of the quantity of repetitions over a second quantity of transmission occasions, wherein the second quantity of transmission occasions is a product of the orthogonal cover code factor and a factor indicating a third quantity of transmission occasions over which to perform rate matching for respective redundancy versions corresponding to each repetition.

20. A non-transitory computer-readable medium storing code for wireless communication, the code comprising instructions executable by one or more processors to:
determine that a UE has data to transmit across a quantity of repetitions using orthogonal cover codes;
determine a set of transmission occasions to which the UE applies a redundancy version sequence associated with the quantity of repetitions; and
transmit the quantity of repetitions starting on an initial transmission occasion of the set of transmission occasions, wherein the initial transmission occasion is available for the UE to start transmitting the quantity of repetitions based at least in part on the redundancy version sequence and in accordance with an orthogonal cover code factor.
